(19) United States
(12) Patent Application Publication
(10) Pub. No.: US 2025/0138249 A1
(43) Pub. Date: May 1, 2025

(54) EXTENDER PORTS, ADAPTER ASSEMBLIES AND OPTICAL ASSEMBLIES INCORPORATING THE SAME

(71) Applicant: CORNING RESEARCH & DEVELOPMENT CORPORATION, CORNING, NY (US)

(72) Inventors: Micah Colen Isenhour, Lexington, NC (US); Ashley Wesley Jones, Denton, TX (US); Zachary Michael Thompson, Austin, TX (US)

(21) Appl. No.: 18/385,752

(22) Filed: Oct. 31, 2023

(51) Int. Cl. G02B 6/38

(52) U.S. Cl. CPC G02B 6/3825; G02B 6/3879; G02B 6/3893; G02B 6/3897

(57) ABSTRACT

Extender ports, adapter assemblies and optical assemblies are disclosed. In one embodiment, an adapter assembly for use in an extender port for coupling a first fiber optic connector and a second fiber optic connector includes an adapter having a first passageway for receiving the first fiber optic connector, a second passageway for receiving the second fiber optic connector, and an integrated sleeve holder positioned between the first passageway and the second passageway. The adapter further includes a sleeve holder insert disposed within the second passageway and adjacent to the integrated sleeve holder, and a sleeve disposed within the integrated sleeve holder and the sleeve holder insert.

### FIELD

The present disclosure is directed to extender ports for coupling fiber optic cables and, more particularly, in-line extender ports having push-button securing members and optical assemblies incorporating the same.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent.

Fiber to the premises (FTTP) is the installation of optical fiber direct to individual buildings such as single-family units, multi-dwelling units, and businesses to provide high-speed broadband access. FTTP dramatically increases connection speeds and reliability for broadband networks compared to legacy copper infrastructure.

It may be difficult and costly to provide optical fiber drop cables to rural subscribers in a FTTP network. Traditional systems are ideal when used in urban areas due to the density of homes (i.e., subscribers) passed, and the relatively short drop cables attached to the main optical cable trunk. However, addressing rural applications is more challenging for present systems. It is difficult to create the longer cable drops needed in a rural environment due to the way these optical cables are manufactured and reeled for deployment. In rural settings it is not uncommon to encounter single family dwellings spread by more than 1000 meters. Not only are the homes more spread out, but they may be a large distance away from the main cable path, requiring lengthy optical cable drops.

Accordingly, a need exists for devices, systems and methods of providing flexibility such that optical cable drops may be provided to rural subscribers in an economical manner.

### SUMMARY

The present disclosure is directed to extender ports for connecting two optical cable drops, thereby extending the length of an optical cable drop when needed. The extender ports are in-line adapters having push-button securing members whereby a fiber optic connector may be released by the single press of a button.

In one embodiment, an adapter assembly for use in an extender port for coupling a first fiber optic connector and a second fiber optic connector includes an adapter having a first passageway for receiving the first fiber optic connector, a second passageway for receiving the second fiber optic connector, and an integrated sleeve holder positioned between the first passageway and the second passageway. The adapter further includes a sleeve holder insert disposed within the second passageway and adjacent to the integrated sleeve holder, and a sleeve disposed within the integrated sleeve holder and the sleeve holder insert.

In another embodiment, an extender port for optically coupling a first fiber optic connector and a second fiber optic connector includes an adapter, a sleeve holder insert, a sleeve, a first push button, a second push button, a first shell and a second shell. The adapter includes a first passageway for receiving the first fiber optic connector and a second passageway for receiving the second fiber optic connector, and an integrated sleeve holder positioned between the first passageway and the second passageway. The sleeve holder insert is disposed within the second passageway and adjacent to the integrated sleeve holder. The sleeve is disposed within the integrated sleeve holder and the sleeve holder insert. The first push-button securing member is coupled to a first end of the adapter and the second push-button securing member is coupled to a second end of the adapter. Each of the first push-button securing member and the second push-button securing member having a bore that defines an inner perimeter. The first shell is coupled to the second shell, and each of the first shell and the second shell have a push-button opening. The first push-button securing member is partially disposed within the push-button opening of the first shell and the second push-button securing member is partially disposed within the push-button opening of the second shell. The first shell is coupled to the adapter such that the first shell encloses a first portion of the adapter and the first push-button securing member. The second shell is coupled to the adapter such that the second shell encloses the first portion of the adapter and the second push-button securing member.

In another embodiment, an optical assembly includes a first fiber optic cable assembly, a second fiber optic cable assembly, an adapter, a sleeve holder insert, a sleeve, a first push button, a second push button, a first shell and a second shell. The first fiber optic cable assembly includes a first optical fiber and a first fiber optic connector, wherein the first optical fiber is disposed within the first fiber optic connector. The second fiber optic cable assembly includes a second optical fiber and a second fiber optic connector, wherein the second optical fiber is disposed within the second fiber optic connector The adapter includes a first passageway for receiving the first fiber optic connector and a second passageway for receiving the second fiber optic connector, and an integrated sleeve holder positioned between the first passageway and the second passageway. The sleeve holder insert is disposed within the second passageway and adjacent to the integrated sleeve holder. The sleeve is disposed within the integrated sleeve holder and the sleeve holder insert. The first push-button securing member is coupled to a first end of the adapter and the second push-button securing member is coupled to a second end of the adapter. Each of the first push-button securing member and the second push-button securing member having a bore that defines an inner perimeter. The first shell is coupled to the second shell, and each of the first shell and the second shell have a push-button opening. The first push-button securing member is partially disposed within the push-button opening of the first shell and the second push-button securing member is partially disposed within the push-button opening of the second shell. The first shell is coupled to the adapter such that the first shell encloses a first portion of the adapter and the first push-button securing member. The second shell is coupled to the adapter such that the second shell encloses the first portion of the adapter and the second push-button securing member.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1A illustrates an exploded perspective view of an example extender port.

FIG. 1B illustrates a perspective view of the example extender port of FIG. 1A.

FIG. 2 illustrates a perspective view of an example optical cable assembly.

FIG. 3 illustrates a perspective view of two optical connectors mated by an example extender port.

FIG. 4 illustrates a cross-sectional view of the example extender port of FIGS. 1A and 1B.

FIG. 5 is a cutaway view of an example adapter of an extender port.

FIG. 6 is a perspective view of an example sleeve holder insert.

FIG. 7 is a close-up cutaway view of passageways of an example adapter.

FIG. 8 is a close-up cutaway view of an example sleeve holder insert disposed within the passageways of the example adapter of FIG. 7.

FIG. 9 is a perspective of an example shell.

FIG. 10A is an elevation view of the example shell of FIG. 9.

FIG. 10B is another perspective view of the example shell of FIG. 9.

FIG. 11 is a perspective view of an example push-button securing member.

FIG. 12A is a side view of the example push-button securing member of FIG. 11 maintained by an end of the example adapter of FIG. 7.

FIG. 12B is a perspective view of the example push-button securing member of FIG. 11 maintained by an end of the example adapter of FIG. 12A.

FIG. 13 is a perspective view of an example push-button securing member inserted into an example shell.

FIG. 14 is a perspective view of an example shell coupled to an example adapter.

FIG. 15 is a cross-sectional view of two example optical connectors inserted into an example adapter.

FIG. 16 is a partial cross-sectional view of a housing connector of an optical connector.

### DETAILED DESCRIPTION

Reference will now be made in detail to the embodiments of the disclosure, examples of which are illustrated in the accompanying drawings. Whenever possible, like reference numbers will be used to refer to like components or parts.

Embodiments of the present disclosure are directed to extender ports for extending optical cable drops into longer lengths, which may be advantageous in deploying a FTTP network in rural settings, or other settings where subscribers are separated by large distances. The extender ports described herein are outdoor/indoor standalone adapters operable to mate two hardened optical connectors, such as PushLok™ optical connectors sold by Corning Optical Communications of Charlotte, NC. If an optical cable drop does not have a sufficient length, an extender port of the present disclosure may be utilized to connect two optical cable drops together to achieve the length needed to reach a subscriber.

The extender ports described herein have the ability to secure an optical connector of an optical drop cable, and release the optical connection with a single push of a button in a single step. The extender ports are further sealed from the environment when connected to two optical connectors, and can withstand a 22 kg axial pull force without damage.

As used herein, the term “extender port” means a device comprising a first connection port for receiving a fiber optic connector and configured for making an optical connection. In one embodiment, the extender port has a first connection port and a second connection port that are aligned for making an optical connection between the two external fiber optic connectors received in the respective connection ports of the device. Consequently, the extender port is advantageous for customizing or extending the length of an optical link by optically connecting two connectorized cable ends with the extender port, thereby providing further flexibility to the network provider for deployments. In other embodiments, the extender port can be fixed to a tether cable for optical connection with an external connector of a connectorized cable, thereby providing a connection node for the network when desired.

Various embodiments of extender ports and optical assemblies including extender ports are described in detail below.

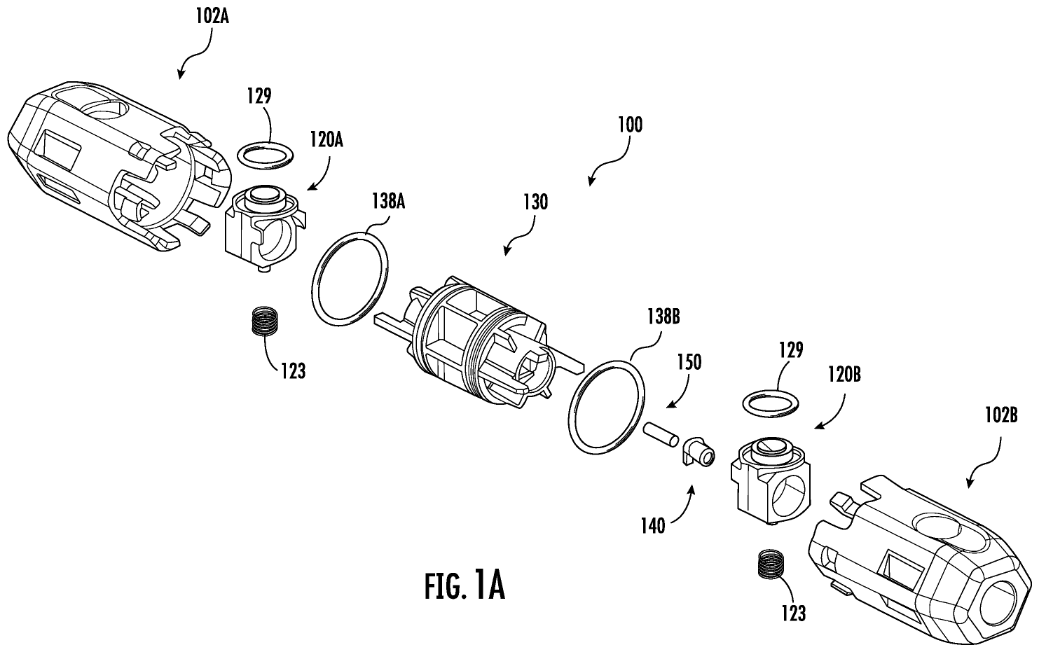

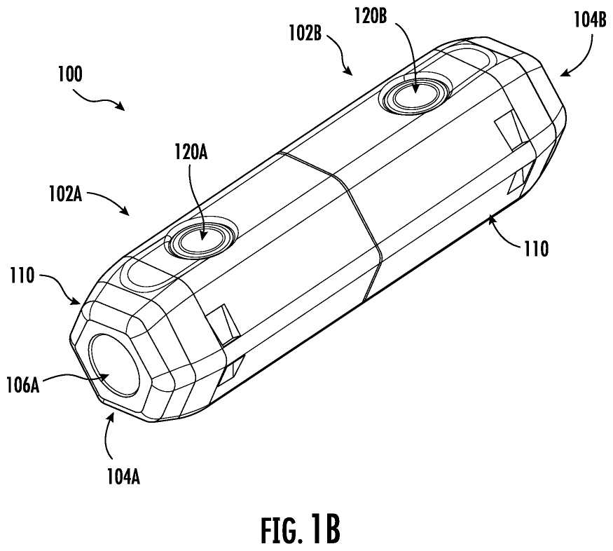

FIGS. 1A and 1B illustrate an example extender port 100 for optically coupling two fiber optic connectors. FIG. 1A is an exploded perspective view of the extender port 100 while FIG. 1B is an assemble perspective view. Generally, the example extender port 100 includes an adapter 130, a sleeve holder insert 140, a sleeve 150, a first push-button securing member 120A, a second push-button securing member 120B, a first shell 102A, and a second shell 102B. The first shell 102A and the second shell 102B each have a shell body 110 made of a rigid material, such as a rigid plastic. The shell body 110 of the first and second shells 102A, 102B environmentally enclose the adapter 130, the sleeve holder insert 140, the sleeve 150, the first push-button securing member 120A, and the second push-button securing member 120B. As described in more detail below, sealing members, such as O-rings, environmentally seal the internal components within the first and second shells 102A, 102B when the first and second shells 102A, 102B are mated together.

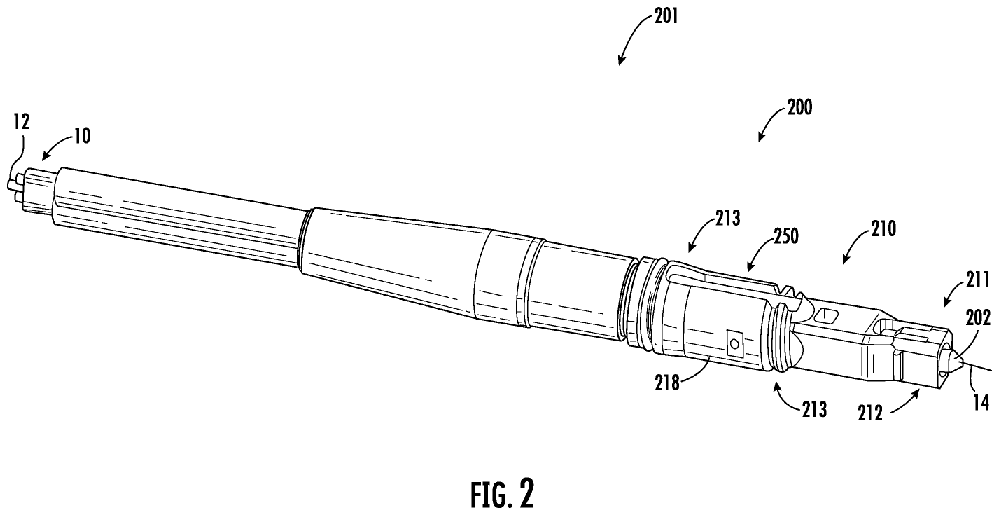

The extender port 100 is configured to optically couple two optical connectors of two optical cable assemblies. The optical connectors described herein may take on a variety of configurations. In a non-limiting example, FIG. 2 illustrates an example fiber optic cable assembly 201 comprising an optical cable 10 having a connectorized end comprising an optical connector 200 configured as a Pushlok™ connector sold by Corning Optical Communications of Charlotte, North Carolina.

The fiber optic connector 200 generally includes a connector housing 210, including a ferrule retaining portion 212 at a front portion 211 of the connector housing 210. The connector housing 210 further includes a rear portion 213 positioned opposite the front portion 211 in an axial direction. The ferrule retaining portion 212 of the connector housing 210 is generally configured to hold and retain a ferrule 202 that is positioned at least partially within the ferrule retaining portion 212.

In embodiments, the fiber optic connector 200 is coupled to a fiber optic cable 10 at the rear portion 213 of the fiber optic connector 200. The fiber optic cable 10 generally includes an optical fiber 12 extending through the fiber optic cable 10. The optical fiber 12 may generally extend through the connector housing 210 and the ferrule 202 along a longitudinal axis 214 of the connector housing 210. For fiber optic cables 10 including a single optical fiber 12, the optical fiber 12 may be coaxial with the longitudinal axis 214. For multifiber cables, this alignment will be orthogonally offset for one, more than one, or all of the optical fibers of the cable.

In embodiments, the connector housing 210 generally includes an outer surface 218 that extends around a perimeter of the connector housing 210, and the outer surface 218 may include one or more cross-sectional shapes. For example, in the embodiment depicted in FIG. 2, the front portion 211 of the connector housing 210 includes a rectangular cross-section including planar sides, while the rear portion 213 of the connector housing 210 includes a curved outer surface 218.

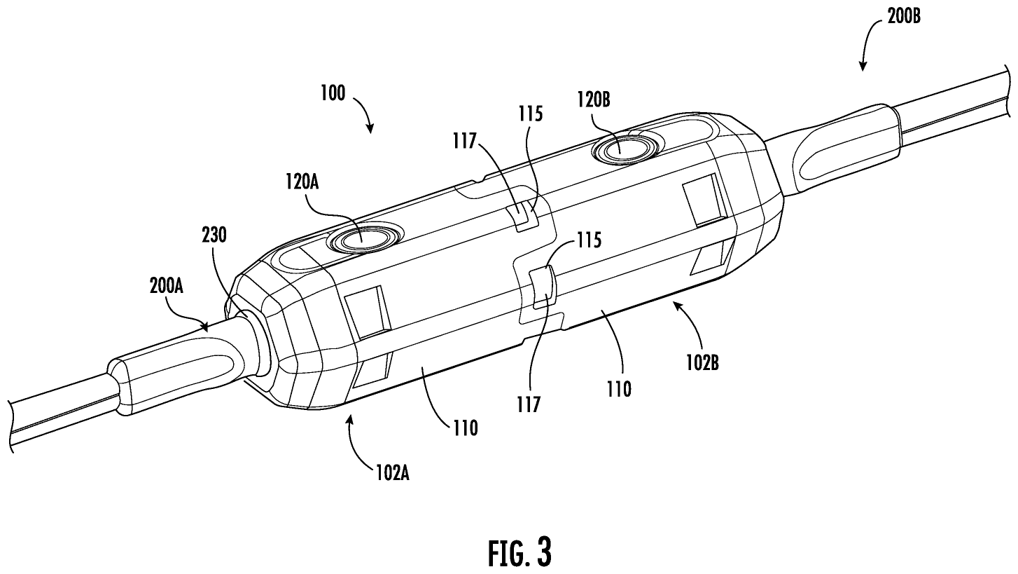

The body 110 of the first shell 102A has an opening that defines a first port 104A for receiving a first optical connector, such as the first optical connector 200A of a first fiber optic cable assembly 200A, as shown in FIG. 3. The body 110 of the second shell 102B has an opening that defines a second port 104B for receiving a second optical connector, such as the second optical connector 210B of a second fiber optic cable assembly 200B, as shown in FIG. 3.

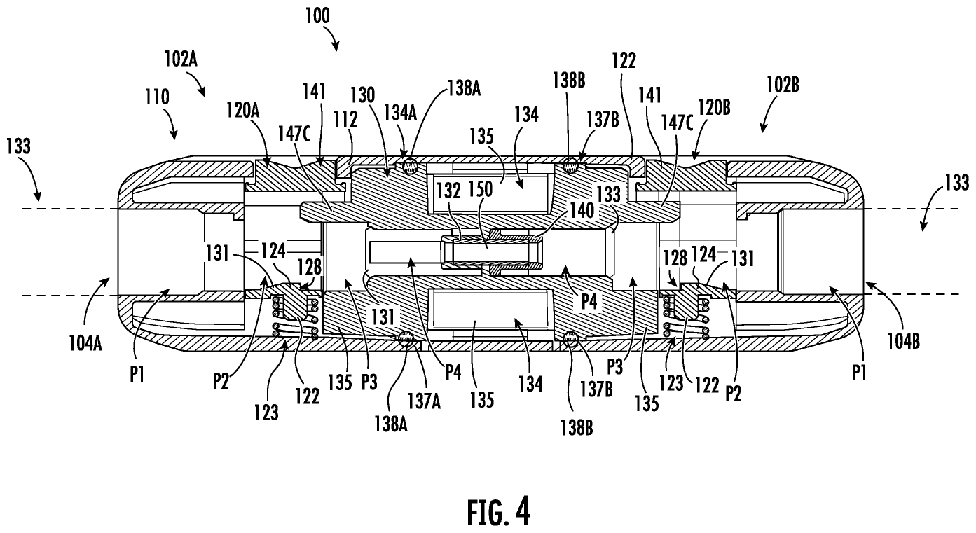

Referring to FIG. 4, which is a cross-sectional view of the extender port 100, the body 110 of the first shell 102A and second shell 102B each comprise a passageway P1 for receiving the first fiber optic connector 210A and the second fiber optic connector 210B. The first shell 102A and the second shell 102B attach together to enclose the adapter 130, the first push-button securing member 120A and the second push-button securing member 120B. The first push-button securing member 120A and the second push-button securing member each include passageway P2 to receive the first fiber optic connector 210A and the second fiber optic connector, respectively. Each end of the adapter 130 includes passageways P3 and P4 shaped and sized to accommodate the different sections of the connector housing 210 of the first and second fiber optic connectors 210A, 210B. As described in more detail below, the adapter 130 facilitates optical mating between the first and second fiber optic connectors 210A, 210B such that optical signals may pass therebetween.

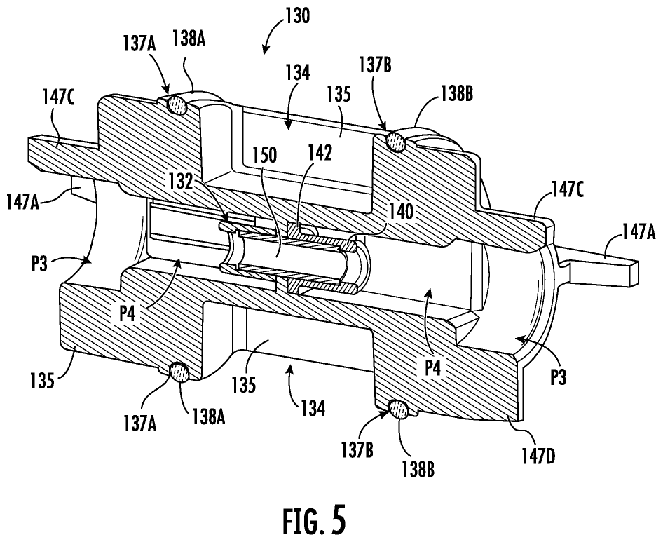

FIG. 5 is a cutaway, perspective view of the example adapter 130. Referring to both FIGS. 4 and 5 the adapter 130 has a first circumferential groove 137A at a first end and a second circumferential groove 137B at a second end. A first O-ring 138A is disposed within the first circumferential groove 137A, and a second O-ring 138B in the second circumferential groove 137B to provide environmental sealing. The first and second O-rings 138A. 138B press against an inner surface of the shell body 110 of the first and second shells 102A, 102B to provide sealing and prevent dust, debris and moisture from entering the adapter 130.

The adapter 130 also includes an integrated sleeve holder 132 positioned between the passageways P4 of the first end and second end of the adapter 130. The integrated sleeve holder 132 is molded or otherwise fabricated to be an integral component of the adapter 130. The sleeve holder insert 140 is disposed within the passageway P4 at an end opposite from the integrated sleeve holder 132 such that the sleeve holder insert 140 is adjacent to the integrated sleeve holder 132. Both the integrated sleeve holder 132 and the sleeve holder insert 140 provide a passageway for receiving a ferrule sleeve 150 that receives the ferrules 202 of the first and second fiber optic connectors 200A, 200B, as described in more detail below.

The sleeve holder insert 140 is configured to be inserted into the passageway P4 and snap into place. FIG. 6 illustrates an example sleeve holder insert 140 according to one embodiment. The sleeve holder insert 140 includes a base 142 that is operable to abut a surface of the integrated sleeve holder 132. A cylindrical ferrule portion 145 extends from a center of base 142, and has an opening 146 for receiving a ferrule of a fiber optic connector 200. A first flexible extension 144A and a second flexible extension 144B extend from a perimeter of the base 142. The first and second flexible extensions 144A, 144B are arms that can flex inwardly toward the ferrule portion 145, and are features that snap and lock the sleeve holder insert 140 into the adapter 130. It should be understood that more or fewer flexible extensions may be provided.

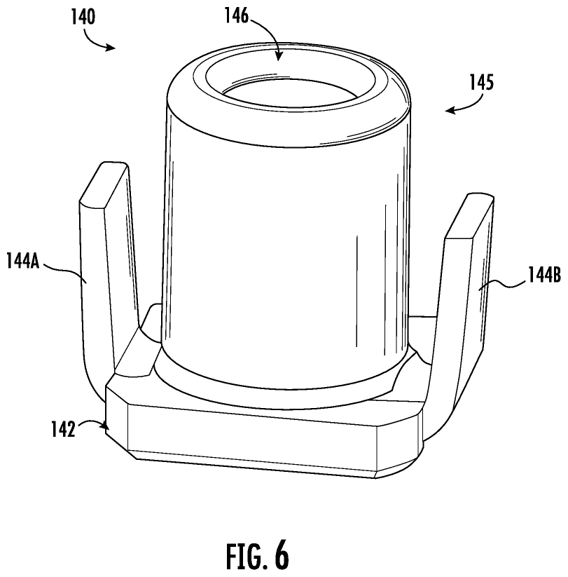

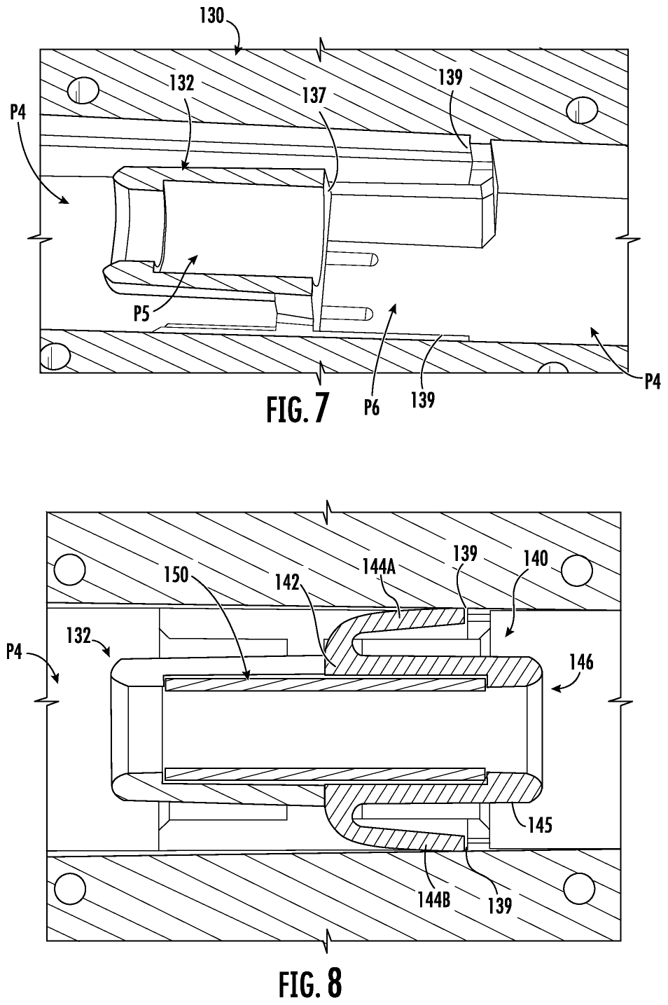

FIG. 7 is a close-up, cutaway view of the integrated sleeve holder 132 and the region of the adapter 130 that receives the sleeve holder insert 140. The integrated sleeve holder 132 has a passageway P5 for receiving the ferrule sleeve 150. A passageway P6 receives the sleeve holder insert 140. An annular protrusion 139 (or multiple individual protrusions) is provided on an interior surface of the adapter 130. The annular protrusion 139 acts as catch for the first and second extensions 144A, 144B. When the sleeve holder insert 140 is inserted into passageway P4, the annular protrusion 139 flexes the first and second extensions 144A, 144B inwardly toward the ferrule portion 145. After the first and second extensions 144A, 144B clear the annular protrusion 139, they snap outward to a position as shown in FIG. 8. The annular protrusion 139 and the position of the first and second extensions 144A, 144B prevent backward movement of the sleeve holder insert 140 back out of passageway P4. It is noted that the ferrule sleeve 150 is inserted into the integrated sleeve holder 132 or the sleeve holder insert 140 prior to insertion of the sleeve holder insert 140 into the adapter 130.

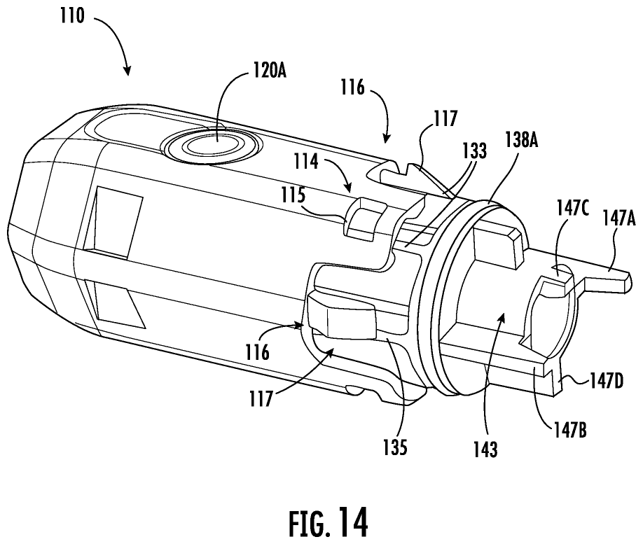

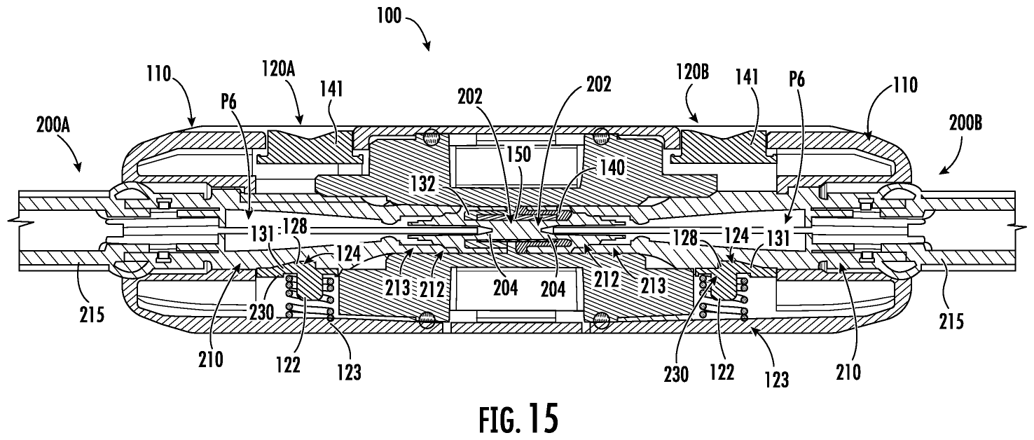

Referring once again to FIG. 5, the outer body of the adapter 130 has plurality of radial fins 135. Recesses 134 are located between adjacent radial fins 135. Referring briefly to FIG. 14, the plurality of radial fins 135 and recesses 134 cooperate with mating features 114, 116 of the first and second shells 102A, 102B to secure the first and second shells 102A, 102B to the adapter 130, and prevent rotation of the adapter 130 within the first and second shells 102A, 102B.

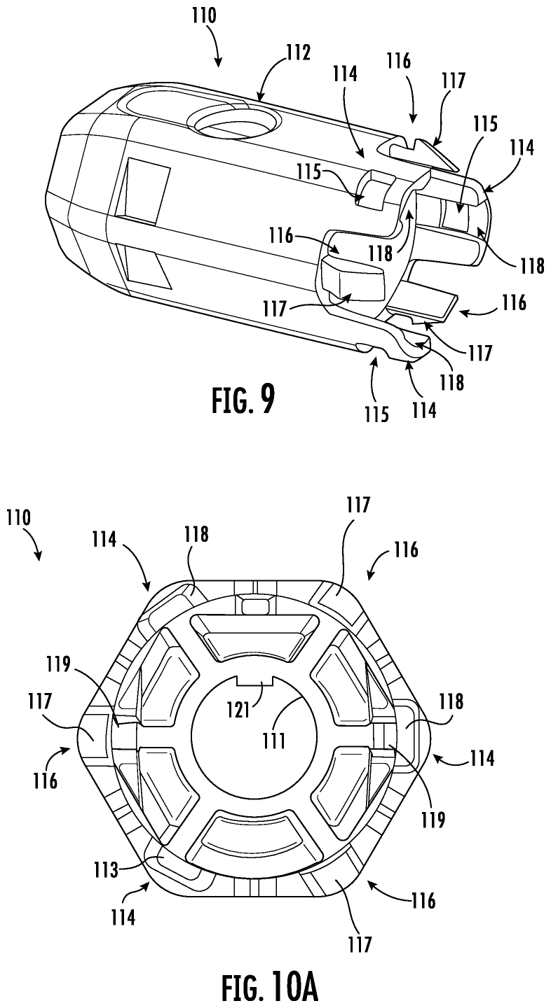

FIG. 9 is a side perspective view of a body 110 of a first shell 102A or a second shell 102B. The body 110 includes a plurality of mating features that are configured to mate with a plurality of mating features of a mated body 110. In the illustrated embodiment, the plurality of mating features comprise alternating first arms 114 and second arms 116. Each first arm 114 comprises a notch 115, and each second arm 116 comprises a prong 117. The prong 117 of the housing of 110 one shell is operable to be disposed in a notch 115 of a first arm 114 of the body 110 of a mated shell to couple the two shells together. Referring once again briefly to FIG. 3, a prong 117 of the body 110 of the second shell 102B is disposed within a notch 115 of the body 110 of the first shell 102A. Likewise, a prong 117 of the body 110 of the first shell 102A is disposed within a notch 115 of the housing of the second shell 102B.

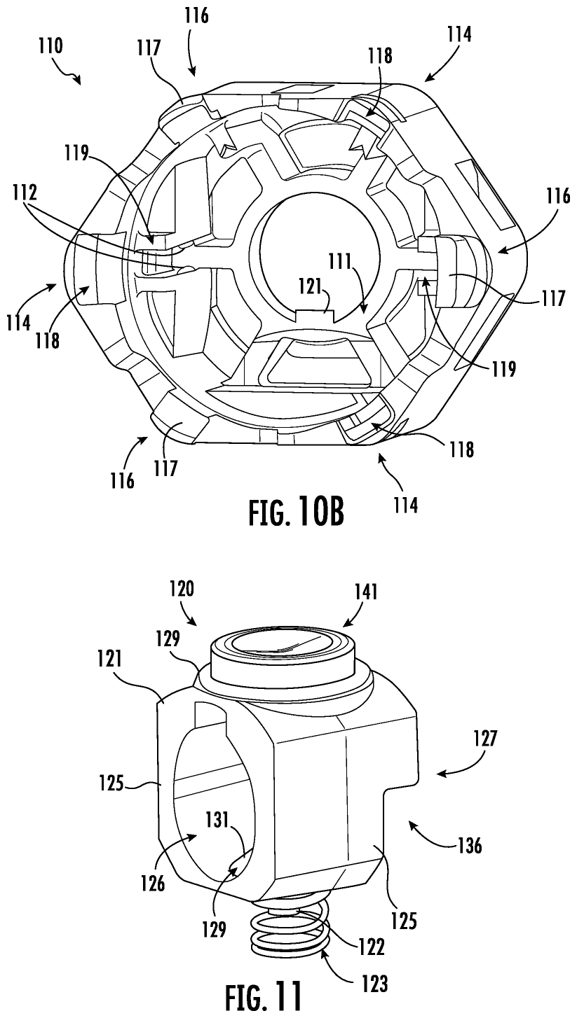

FIG. 10A is a rear end view of the body 110, and FIG. 10B is a rear perspective view of the body 110. Each of the first arms 114 includes a groove 118 that is operable to receive an individual radial fin 135, as shown in FIG. 14. In the illustrated embodiment, the second arms 116 do not include a groove. However, grooves may be provided on the second arms 116 in some embodiments. At least a portion of the plurality of radial fins 135 are disposed within the grooves 118 of the first arms 114 and/or second arms 116. In the illustrated embodiment, a portion of the plurality of radial fins 135 are disposed within the groove 118 of the first arm 114 to prevent rotation of the adapter with respect to the body 110.

Still referring to FIG. 14, each end of the adapter 130 includes a set of arms in the form of a first arm 147A, a second arm 147B, a third arm 147C, and a fourth arm 147D. The first and second arms 147A, 147B are operable to maintain a push-button securing member 120 as described in more detail below. Referring again to FIGS. 10A and 10B, an interior wall 111 of the shell has engagement recesses 119 that are configured to receive the ends of the first arm 147A and the second arm 147B. The engagement recesses may include protrusions 112 that compress against the first arm 147A and second arm 147B to ensure a secure connection.

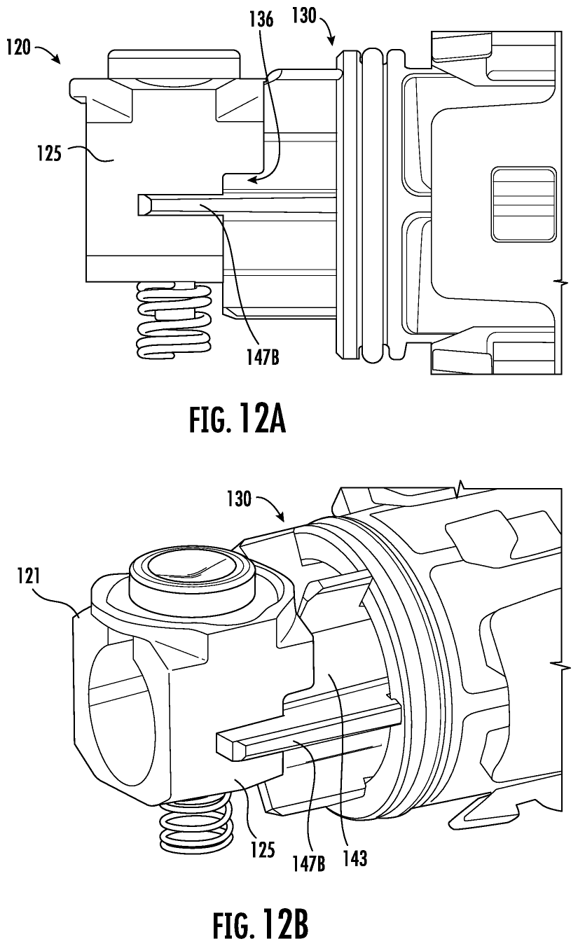

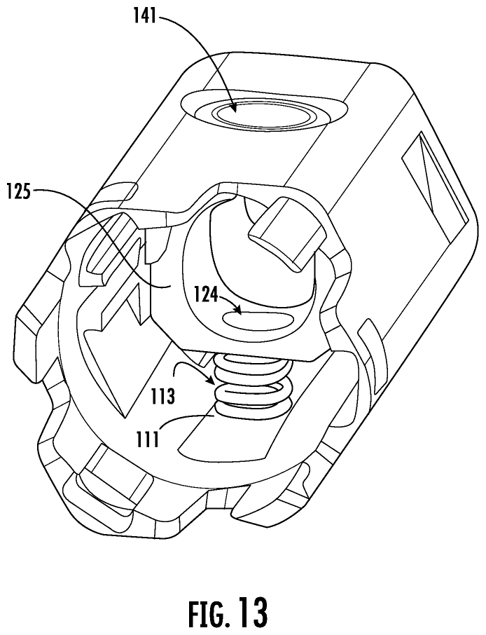

As stated above, each body 110 maintains a push-button securing member 120, an example of which is illustrated in FIG. 11. The push-button securing member 120 generally includes a main body 121 with generally flat sides 125 configured to contact the first and second arms 147A, 147B of the adapter 130 as shown in FIGS. 12A and 12B to retain the push-button securing member 120 within the body 110. A rear surface of the main body 127 of the push-button securing member 120 has a notched portion 136 to provide clearance for an end portion 143 of the adapter 130. More particularly, the width at the top of the push-button securing member 120 is dictated by the sealing member 129 to create a support for the sealing member 129 to press against as it seals on the underside of body 110. Arm 147C acts as a hard stop for the push-button securing member 120 so it cannot be over-compressed. The notch portion 136 is present to allow additional extension of the adapter 130 to support arms 147A, 147B, 147C, and 147D more adequately, and provide a strong, consistent envelope for the fiber optic connector 200.

The push-button securing member 120 generally defines a bore 126 extending through the push-button securing member 120 that defines an inner perimeter. While the bore 126 is depicted as having a circular shape, it should be understood that the bore 126 may include any suitable shape for receiving a fiber optic connector 200.

The push-button securing member 120 includes a button portion 141 that defines a button for the user to press to lower the push-button securing member 120 into a disengaged state so that a fiber optic connector may be removed from the extender port 100. In embodiments, a sealing member 129, such as an O-ring, is provided around the button portion 141 to provide environmental sealing between the push-button securing member 120 and the body 110.

The push-button securing member 220 includes a locking portion 124 including a connector engagement face 128 positioned on the bore 126 (FIGS. 4 and 15). When installed to the body 110, in some embodiments, the connector engagement face 128 is generally oriented transverse to the corresponding connector insertion path 133 (FIG. 4), and defines a locking portion recess that is generally obstructed from the open end of the connector insertion path 133 by the connector engagement face 128.

The push-button securing member 120 further includes a ramp 131 that extends between the inner perimeter of the bore 126 to the inner end of the connector engagement face 128, such that the ramp 131 is upward and forward facing when the push-button securing member 120 is positioned within the shell body 110. In embodiments, the ramp 131 of each the push-button securing member 120 is positioned forward of the connector engagement face 128 of the push-button securing member 120. In other words, the ramp 131 of the push-button securing member 120 is positioned closer to the front end of the body 110 than the connector engagement face 128 of the push-button securing member 120. In this way, the ramp 131 may contact a fiber optic connector 200 being inserted along the connector insertion path 133 prior to the connector engagement face 128, as described in greater detail herein.

In some embodiments, the connector engagement face 128 of the push-button securing member 120 defines a plane that is orthogonal to the connector insertion path 133. In other embodiments, the connector engagement face 128 of the push-button securing member 120 is oriented such that it is non-orthogonal to the connector insertion path 133.

Referring to FIGS. 4, 11 and 15, the push-button securing member 120 further includes a resilient member post 122 operable to receive a resilient member 123. The resilient member 123 may bias the push-button securing member 120, and may generally include a spring, such as and without limitation a compression spring, a tension spring, a torsion spring, or the like. In embodiments, the resilient member 123 include a spring constant of between about 10 newtons per millimeter and about 50 newtons per millimeter, inclusive of the endpoints. In another embodiment, the resilient member 123 includes a spring constant of between about 12 newtons per millimeter and about 16 newtons per millimeter, inclusive of the endpoints. Increasing the spring constant may increase a force required to move the push-button securing member 120 between an engaged position and a disengaged position. The resilient member 123 may include a free length of between about 3 millimeters and about 20 millimeters, inclusive of the endpoints. In one embodiment, the resilient member 123 has a free length of between about 5 millimeters and about 8 millimeters, inclusive of the endpoints.

The push-button securing member 120 is repositionable between an engaged position, in which the locking portion 124 of the push-button securing member 120 is positioned within and intersects the corresponding connector insertion path 133 and a disengaged position, in which the locking portion 124 is spaced apart from the corresponding connector insertion path 133. More particularly, the push-button securing member 120 is repositionable between an engaged position, in which the connector engagement face 128 of the push-button securing member 120 is positioned within and intersects the corresponding connector insertion path 133, and a disengaged position, in which the connector engagement face 128 is spaced apart from the corresponding connector insertion path 133.

In embodiments, the resilient member 123 biases the push-button securing member 120 into the engaged position, such that a force must be applied to resilient member 123 to reposition the push-button securing member 120 into the disengaged position.

FIG. 15 is a cross-sectional view of the extender port 100 with a first fiber optic connector 200A and a second fiber optic connector 200B inserted therein. The locking portions 124 of the first push-button securing members 120A and the second push-button securing members 120B are engaged with corresponding locking portions 230 of first fiber optic connector 200A and the second fiber optic connector 200B. In this engaged state, the first fiber optic connector 200A and the second fiber optic connector 200B cannot be removed from the extender port 100.

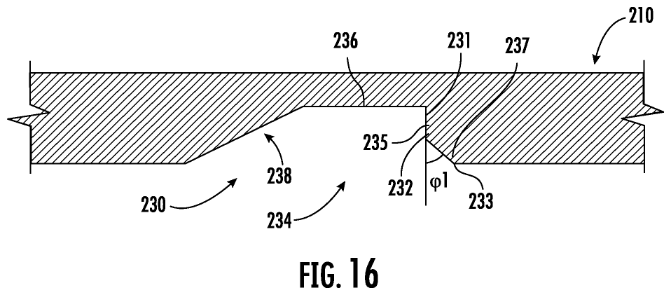

FIG. 16 illustrates an example locking portion 230 of a fiber optic connector. The locking portion 230 includes a locking portion recess 234 positioned rearward of the port engagement face 232. The locking portion recess 234 includes a generally planar surface 236 that is oriented transverse to the port engagement face 232 and that extends at least partially across the outer surface 218 of the connector housing 210. The locking portion recess 234 may also include a ramp portion 238 positioned rearward of the planar surface 236 and that extends outward from the planar surface 236 to a nominal housing portion moving along the locking portion recess 234 in the retracting direction.

In embodiments, the port engagement face 232 extends inward from the outer surface 218 of the connector housing 210 by a distance that corresponds to features of a push-button securing member 120 such that the connector housing 210 may be selectively coupled to and removed from the push-button securing member 120.

The port engagement face 232 generally defines a planar surface that is oriented transverse to the longitudinal axis of the connector. The port engagement face 232 includes and extends between an inner end 231 and an outer end 233 that is positioned outward of the inner end 231. The outer end 233 may include a rounded or chamfered edge, which may assist in preventing breakage of the outer end 233 when the connector housing 210 is forcibly removed from a connection port.

In some embodiments, the outer end 233 is positioned closer to the front portion 211 of the connector housing 210 in an axial direction than the inner end 231, such that the port engagement face 232 is both rearward and outward facing. In these embodiments, the port engagement face 232 generally defines a plane that intersects the longitudinal axis of the connector at an angle that is less than 30 degrees evaluated from perpendicular.

In some embodiments, the port engagement face 232 may include a locking face 235 that extends in a plane that is orthogonal to the longitudinal axis of the fiber optic connector, and a release face 237 positioned outward from the locking face 235. In the embodiment depicted in FIG. 16, the release face 237 extends in a plane that intersects the locking face 235 at an angle φ1. In embodiments, the angle φ1 is between about 0 degrees and 30 degrees, inclusive of the endpoints, such that the release face 237 is outward and rearward facing. By including both a locking face 235 that extends in a plane that is orthogonal to the longitudinal axis of the fiber optic connector and a release face 237 that is outward and rearward facing, the port engagement face 232 of the connector housing 210 may be rigidly connected to a push-button securing member 120 engaged with the locking face 235. However, the port engagement face 232 of the connector housing may be releasably engaged with a push-button securing member 120 engaged with the release face 237 upon the application of a force above a predetermined threshold.

Referring again to FIG. 15, to remove the fiber optic connector (i.e., the first fiber optic connector 200A and/or the second fiber optic connector 200B) from the extender port 100, the push-button securing member 120 is moved from the engaged position into a disengaged position by moving the push-button securing member 120 downward (e.g., in the vertical direction as depicted). For example, the push-button securing members 120A, 120B may be moved to the disengaged position by depressing a top surface of the button portion 141 of the push-button securing member 120 to overcome the biasing force of the resilient member 123. In one embodiment, the push-button securing member may be repositioned into the disengaged position under a force exceeding a predetermined threshold between 5 newtons and 50 newtons applied to the push-button securing member 120 in a direction that is transverse to the axis extending along the corresponding connector insertion path 133. In another embodiment, the push-button securing member 120 may be repositioned into the disengaged position under a force exceeding a predetermined threshold between 20 newtons and 25 newtons applied to the push-button securing member in a direction that is transverse to the axis extending along the corresponding connector insertion path 133.

It should now be understood that embodiments of the present disclosure provide extender ports having push-button securing members that enable optical drop cables to be quickly and cost-efficiently extended. The extender ports used herein may be advantageous in providing FTTP networks in locations where subscribers are sparsely distributed, such as rural areas.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

1. An adapter assembly for use in an extender port for coupling a first fiber optic connector and a second fiber optic connector, the adapter assembly comprising:
an adapter comprising:
a first passageway for receiving the first fiber optic connector and a second passageway for receiving the second fiber optic connector; and
an integrated sleeve holder positioned between the first passageway and the second passageway;
a sleeve holder insert disposed within the second passageway and adjacent to the integrated sleeve holder; and
a sleeve disposed within the integrated sleeve holder and the sleeve holder insert.

2. The adapter assembly of claim 1, wherein:
the sleeve holder insert comprises at least one flexible extension;
an interior surface of the second passageway of the adapter comprises a groove; and
the at least one flexible extension is disposed within the groove to secure the sleeve holder insert within the adapter.

3. The adapter assembly of claim 1, wherein the adapter comprises a first circumferential groove at a first end and a second circumferential groove at a second end, a first O-ring within the first circumferential groove, and a second O-ring in the second circumferential groove.

4. The adapter assembly of claim 1, wherein the adapter comprises a plurality of radial fins.

5. The adapter assembly of claim 1, wherein each of a first end and a second end of the adapter comprises an alignment protrusion operable to be disposed within an alignment notch of a push-button securing member.

6. An extender port for optically coupling a first fiber optic connector and a second fiber optic connector, the extender port comprising:
an adapter comprising:
a first passageway for receiving the first fiber optic connector and a second passageway for receiving the second fiber optic connector; and
an integrated sleeve holder positioned between the first passageway and the second passageway;
a sleeve holder insert disposed within the second passageway and adjacent to the integrated sleeve holder;
a sleeve disposed within the integrated sleeve holder and the sleeve holder insert;
a first push-button securing member coupled to a first end of the adapter and a second push-button securing member coupled to a second end of the adapter, each of the first push-button securing member and the second push-button securing member comprising a bore, the bore defining an inner perimeter; and
a first shell and a second shell, each of the first shell and the second shell comprising a push-button opening, wherein:
the first push-button securing member is partially disposed within the push-button opening of the first shell and the second push-button securing member is partially disposed within the push-button opening of the second shell;
the first shell is coupled to the adapter such that the first shell encloses a first portion of the adapter and the first push-button securing member; and
the second shell is coupled to the adapter such that the second shell encloses the first portion of the adapter and the second push-button securing member.

7. The extender port of claim 6, wherein:
the first shell, the bore of the first push-button securing member, the first passageway, and the sleeve within the integrated sleeve holder are each configured to be disposed about the first fiber optic connector; and
the second shell, the bore of the second push-button securing member, the second passageway, and the sleeve within the sleeve holder insert are each configured to be disposed about the second fiber optic connector.

8. The extender port of claim 6, wherein each of the first shell and the second shell comprises a plurality of mating features such that the plurality of mating features of the first shell mates with the plurality of mating features of the second shell.

9. The extender port of claim 8, wherein the plurality of mating features comprises a plurality of first mating features and a plurality of second mating features, the plurality of first mating features comprising a first arm and a notch, and the plurality of second mating features comprising a second arm and a prong, and wherein the prong of the first shell is operable to be seated within the notch of the second shell and the prong of the second shell is operable to be seated within the notch of the first shell to couple the first shell to the second shell.

10. The extender port of claim 6, wherein the first shell and the second shell are hexagonal in cross-section.

11. The extender port of claim 10, wherein:
the adapter comprises a plurality of radial fins;
an interior surface of the first shell and the second shell comprises a plurality of grooves; and
at least a portion of the plurality of six radial fins of the adapter are disposed within the plurality of grooves of the first shell and the second shell.

12. The extender port of claim 6, wherein:
each of the first push-button securing member and the second push-button securing member comprises an alignment notch; and
each of the first end and the second end of the adapter comprises an alignment protrusion operable to be disposed within the alignment notch.

13. The extender port of claim 6, wherein each of the first push-button securing member and the second push-button securing member further comprises:
a connector engagement face positioned on the bore and oriented transverse to a corresponding connector insertion path, the connector engagement face comprising an inner end and an outer end positioned outward of the inner end; and
a ramp positioned on the bore, the ramp extending between the inner perimeter of the bore and the inner end of the connector engagement face.

14. The extender port of claim 13, wherein each of the first push-button securing member and the second push-button securing member is repositionable between an engaged position and disengaged position, wherein in the engaged position the connector engagement face of the first push-button securing member and the second push-button securing member intersects the corresponding connector insertion path and wherein in the disengaged position the connector engagement face of the first push-button securing member and the second push-button securing member is spaced apart from the corresponding connector insertion path.

15. The extender port of claim 14, further comprising a first resilient member and a second resilient member engaged with the first push-button securing member and the second push-button securing member, respectively, and wherein the first resilient member and the second resilient member bias the first push-button securing member and the second push-button securing member into the engaged position.

16. The extender port of claim 13, wherein the connector engagement face of each of the first push-button securing member and the second push-button securing member defines a plane that is perpendicular to the corresponding connector insertion path.

17. The extender port of claim 6, wherein:
the sleeve holder insert comprises at least one flexible extension;
an interior surface of the second passageway of the adapter comprises a groove; and
the at least one flexible extension is disposed within the groove to secure the sleeve holder insert within the adapter.

18. The extender port of claim 6, wherein the adapter comprises a first circumferential groove at the first end and a second circumferential groove at the second end, a first O-ring within the first circumferential groove, and a second O-ring in the second circumferential groove.

19. An optical assembly comprising:
a first fiber optic cable assembly comprising a first optical fiber and a first fiber optic connector, wherein the first optical fiber is disposed within the first fiber optic connector;
a second fiber optic cable assembly comprising a second optical fiber and a second fiber optic connector, wherein the second optical fiber is disposed within the second fiber optic connector;
an adapter comprising:
a first passageway for receiving the first fiber optic connector and a second passageway for receiving the second fiber optic connector; and
an integrated sleeve holder positioned between the first passageway and the second passageway;
a sleeve holder insert disposed within the second passageway and adjacent to the integrated sleeve holder;
a sleeve disposed within the integrated sleeve holder and the sleeve holder insert;
a first push-button securing member coupled to a first end of the adapter and a second push-button securing member coupled to a second end of the adapter, each of the first push-button securing member and the second push-button securing member comprising a bore, the bore defining an inner perimeter; and
a first shell and a second shell, each of the first shell and the second shell comprising a push-button opening,
wherein:
the first push-button securing member is partially disposed within the push-button opening of the first shell and the second push-button securing member is partially disposed within the push-button opening of the second shell;
the first shell is coupled to the adapter such that the first shell encloses a first portion of the adapter and the first push-button securing member; and
the second shell is coupled to the adapter such that the second shell encloses the first portion of the adapter and the second push-button securing member.

20. The optical assembly of claim 19, wherein:
the first fiber optic connector is removably disposed within the first shell, the bore of the first push-button securing member, the first passageway, and the sleeve within the integrated sleeve holder; and
the second fiber optic connector is removably disposed within the second shell, the bore of the second push-button securing member, the second passageway, and the sleeve within the sleeve holder insert.

21. The optical assembly of claim 19, wherein each of the first shell and the second shell comprises a plurality of mating features such that the plurality of mating features of the first shell mates with the plurality of mating features of the second shell.

22. The optical assembly of claim 21, wherein the plurality of mating features comprises a plurality of first mating features comprising a first arm and a notch, and a plurality of second mating features comprising a second arm and a prong, and wherein the prong of the first shell is operable to be seated within the notch of the second shell and the prong of the second shell is operable to be seated within the notch of the first shell to couple the first shell to the second shell.

23. The optical assembly of claim 19, wherein the first shell and the second shell are hexagonal in cross-section.

24. The optical assembly of claim 23, wherein:
the adapter comprises a plurality of radial fins;
an interior surface of the first shell and the second shell comprises a plurality of grooves; and
at least a portion of the plurality of radial fins of the adapter are disposed within the plurality of grooves of the first shell and the second shell.

25. The optical assembly of claim 19, wherein:
each of the first push-button securing member and the second push-button securing member comprises an alignment notch; and
each of the first end and the second end of the adapter comprises an alignment protrusion operable to be disposed within the alignment notch.

26. The optical assembly of claim 19, wherein each of the first push-button securing member and the second push-button securing member further comprises:
a connector engagement face positioned on the bore and oriented transverse to a corresponding connector insertion path, the connector engagement face comprising an inner end and an outer end positioned outward of the inner end; and
a ramp positioned on the bore, the ramp extending between the inner perimeter of the bore and the inner end of the connector engagement face.

27. The optical assembly of claim 26, wherein each of the first push-button securing member and the second push-button securing member is repositionable between an engaged position and a disengaged position, wherein in the engaged position the connector engagement face of the first push-button securing member and the second push-button securing member intersects the corresponding connector insertion path and wherein the disengaged position the connector engagement face of the first push-button securing member and the second push-button securing member is spaced apart from the corresponding connector insertion path.

28. The optical assembly of claim 27, further comprising a first resilient member and a second resilient member engaged with the first push-button securing member and the second push-button securing member, respectively, and wherein the first resilient member and the second resilient member bias the first push-button securing member and the second push-button securing member into the engaged position.

29. The optical assembly of claim 26, wherein the connector engagement face of each of the first push-button securing member and the second push-button securing member defines a plane that is perpendicular to the corresponding connector insertion path.

30. The optical assembly of claim 19, wherein each of the first fiber optic connector and the second fiber optic connector further comprises a ferrule comprising an optical fiber bore and a connector housing, wherein first optical fiber and the second optical fiber are disposed within the optical fiber bore of the first fiber optic cable assembly and the second fiber optic cable assembly, respectively, and the connector housing comprises:
a ferrule retaining portion positioned at a front portion of the connector housing, the ferrule retaining portion structurally configured to engage and retain the ferrule;
a longitudinal axis extending from the front portion of the connector housing, through the ferrule retaining portion to a rear portion of the connector housing positioned opposite the front portion;
a nominal housing portion defined on an outer surface of the connector housing; and
a locking portion defined on the outer surface of the connector housing and interrupting the nominal housing portion, wherein the locking portion comprises a port engagement face that extends inward from the nominal housing portion of the connector housing toward the longitudinal axis and that is oriented transverse to the longitudinal axis, and the locking portion further comprises a locking portion recess positioned rearward of the port engagement face and inward of the nominal housing portion of the connector housing, and the locking portion recess is oriented transverse to the port engagement face and comprises a planar surface extending across at least a portion of the outer surface of the connector housing.

31. The optical assembly of claim 19, wherein:
the sleeve holder insert comprises at least one flexible extension;
an interior surface of the second passageway of the adapter comprises a groove; and
the at least one flexible extension is disposed within the groove to secure the sleeve holder insert within the adapter.

32. The optical assembly of claim 19, wherein the adapter comprises a first circumferential groove at the first end and a second circumferential groove at the second end, a first O-ring within the first circumferential groove, and a second O-ring in the second circumferential groove.
